(19) United States
(12) Patent Application Publication
(10) Pub. No.: US 2013/0334911 A1
(43) Pub. Date: Dec. 19, 2013

(54) ELECTRIC MOTOR INCLUDING A POSITIVE PRESSURE INTRODUCTION SYSTEM AND METHOD

(71) Applicants: Andrew Meyer, Fishers, IN (US); Thomas Bockelmann, Knightstown, IN (US)

(72) Inventors: Andrew Meyer, Fishers, IN (US); Thomas Bockelmann, Knightstown, IN (US)

(73) Assignee: REMY TECHNOLOGIES, L.L.C., Pendleton, IN (US)

(21) Appl. No.: 13/495,658

(22) Filed: Jun. 13, 2012

(51) Int. Cl. H02K 9/19

(52) U.S. Cl. 310/54

(57) ABSTRACT

An electric machine includes a housing having an interior portion, a stationary member including a stationary field is fixedly mounted to the housing and a movable member including a rotating field is rotatably mounted relative to the stationary member. A positive pressure introduction system is fluidically coupled to the housing. The positive pressure introduction system is configured and disposed to raise an internal pressure of the interior portion of the housing.

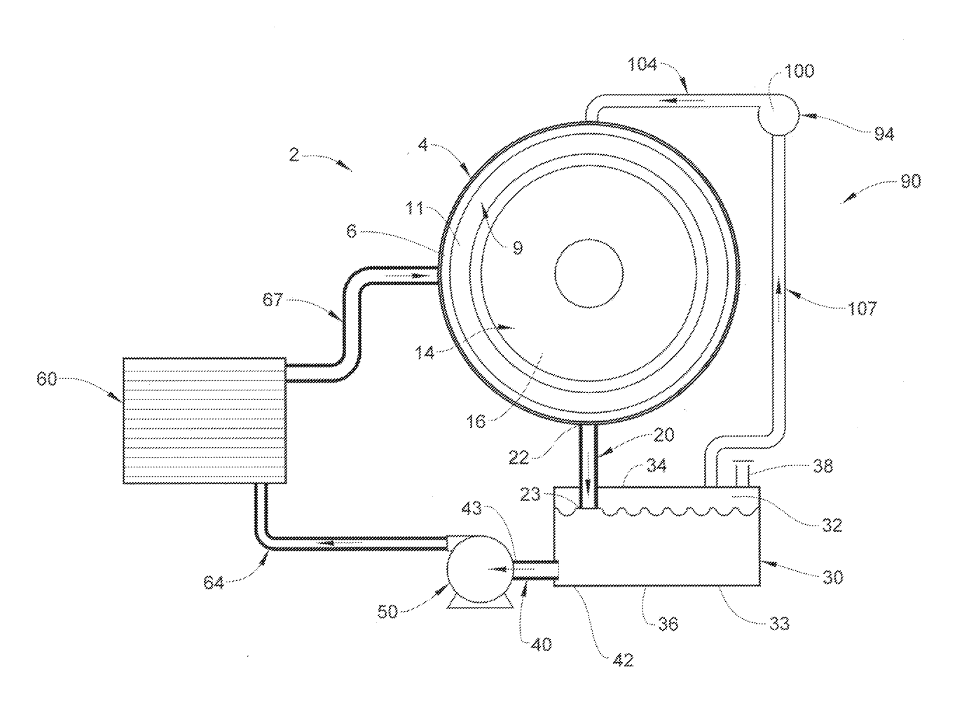

### BACKGROUND OF THE INVENTION

Exemplary embodiments pertain to the art of electric machines and, more particularly, to an electric machine having a positive pressure introduction system and method.

Electric machines generally include a housing, a stationary member having a stationary field mounted to the housing, and a rotating member having a rotating field that rotates relative to the stationary member. The rotating member is supported by bearings arranged in the housing. During operation, heat develops in the stationary field as a result of electrical flow. In order to limit the amount of heat in the housing, electric machines usually include a cooling system. The cooling system may take the form of a fan that draws air through the housing, or an oil based system that passes oil in a heat exchange relationship over portions of the electric motor.

### BRIEF DESCRIPTION OF THE INVENTION

Disclosed is an electric machine including a housing having an interior portion, a stationary member including a stationary field is fixedly mounted to the housing and a movable member including a rotating field is rotatably mounted relative to the stationary member. A positive pressure introduction system is fluidically coupled to the housing. The positive pressure introduction system is configured and disposed to raise an internal pressure of the interior portion of the housing.

Also disclosed is a method of circulating coolant through an electric machine. The method includes introducing a liquid coolant into a housing of the electric machine, creating a positive pressure within the housing, and urging the liquid coolant through the positive pressure toward a drain in the housing.

### BRIEF DESCRIPTION OF THE DRAWINGS

The following descriptions should not be considered limiting in any way. With reference to the accompanying drawings, like elements are numbered alike:

The FIGURE depicts an electric motor including a positive pressure introduction system in accordance with an exemplary embodiment.

### DETAILED DESCRIPTION OF THE INVENTION

A detailed description of one or more embodiments of the disclosed apparatus and method are presented herein by way of exemplification and not limitation with reference to the FIGURE.

An electric machine, constructed in accordance with an exemplary embodiment, is indicated generally at 2 in the FIGURE. Electric machine 2 includes a housing 4 having an interior portion 6. A stationary member 9 is mounted to an inner surface (not separately labeled) of housing 4. Stationary member 9 includes a stationary field 11. A moveable member 14 is arranged within interior portion 6. Moveable member 14 includes a rotary field 16 that is configured to rotate relative to stationary member 9. Housing 4 is also shown to include a liquid drain 20 having a first end 22 fluidically connected to interior portion 6 and a second end 23 fluidically connected to a coolant reservoir 30.

Coolant reservoir 30 includes a coolant holding zone 32 that stores an amount of coolant 33, such as oil, circulated through interior portion 6 of housing 4. Coolant reservoir 30 includes an upper portion 34 and a lower portion 36. Upper portion 34 includes a vent 38 that fluidically connects coolant holding zone 32 and ambient. Lower portion 36 includes an outlet 40. Outlet 40 includes a first end portion 42 fluidically connected to coolant holding zone 32 and a second end portion 43 that is fluidically connected to a coolant pump 50. Coolant pump 50 is fluidically connected to a cooler 60 through a first coolant conduit 64. Cooler 60 is fluidically coupled to interior portion 6 of housing 4 through a second coolant conduit 67.

With this arrangement, coolant 33 flowing from housing 4 accumulates in coolant reservoir 30. Coolant pump 50 urges coolant 33 from coolant reservoir 30 into cooler 60. Cooler 60 passes coolant 33 in a heat exchange relationship with another medium, such as an air flow. The air flow removes heat entrained in coolant 33. Coolant 33 then flows back into housing 4 to exchange heat with, for example, stationary field 11. At this point, while the coolant 33 is described as being an oil, other cooling mediums may also be employed. In order to urge coolant 33 toward liquid drain 20, electric machine 2 includes a positive pressure introduction system 90 coupled to housing 4.

In accordance with an exemplary embodiment, positive pressure introduction system 90 includes a pump 94. In accordance with one aspect of the exemplary embodiment, pump 94 takes the form of a low pressure air pump 100. It should however be understood that other forms of pumps may be employed. Pump 94 is fluidically connected to interior portion 6 of housing 4 through a first conduit 104. Pump 94 is operated to introduce a gas flow into housing 4 to raise an internal pressure of interior portion 6. Raising pressure within interior portion 6 helps urge coolant 33 to coolant reservoir 30. The positive pressure also helps prevent ingress of external, undesirable contaminates such as water, dust and the like. Prior art scavenging systems create a negative pressure within the housing 4. In addition to requiring a high volume pump capable of self-priming, creating a negative pressure often times allows external contaminants, such as water, to be drawn into the housing 4. In contrast, the use of positive pressure inhibits external contaminants from entering housing 4. Pump 94 is also shown connected to upper portion 34 of coolant reservoir 30 through a second conduit 107. It should however be understood that pump 94 can draw in supply air from a number of sources.

While the invention has been described with reference to an exemplary embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof Therefore, it is intended that the invention not be limited to the particular embodiment disclosed as the best mode contemplated for carrying out this invention, but that the invention will include all embodiments falling within the scope of the claims.

What is claimed is:

1. An electric machine comprising:
a housing including an interior portion;
a stationary member including a stationary field fixedly mounted to the housing;
a movable member including a rotary field rotatably mounted relative to the stationary member; and
a positive pressure introduction system fluidically coupled to the housing, the positive pressure introduction system being configured and disposed to raise an internal pressure of the interior portion of the housing.

2. The electric machine according to claim 1, wherein in positive pressure introduction system comprises a pump configured and disposed to introduce a gas into the housing.

3. The electric machine according to claim 2, wherein the pump comprises a low pressure air pump.

4. The electric machine according to claim 1, further comprising: a liquid drain fluidically connected to the housing.

5. The electric machine according to claim 4, further comprising: a coolant reservoir fluidically connected to the liquid drain.

6. The electric machine according to claim 5, further comprising: a vent fluidically connected to the coolant reservoir.

7. The electric machine according to claim 5, further comprising: a coolant pump fluidically connected to the coolant reservoir and the housing.

8. The electric machine according to claim 7, further comprising: a cooler fluidically connected between the coolant reservoir and the housing.

9. The electric machine according to claim 8, wherein the cooler is fluidically connected between the coolant pump and the housing.

10. A method of circulating coolant through an electric machine, the method comprising:
introducing a liquid coolant into a housing of the electric machine;
creating a positive pressure within the housing; and
urging the liquid coolant through the positive pressure introduction system toward a liquid drain in the housing.

11. The method of claim 10, further comprising: discharging the liquid coolant from the housing through the liquid drain.

12. The method of claim 11, further comprising: passing the liquid coolant from the housing into a coolant reservoir.

13. The method of claim 12, further comprising: venting the positive pressure from the coolant reservoir.

14. The method of claim 12, further comprising: guiding the liquid coolant into a cooler.

15. The method of claim 14, wherein guiding the liquid coolant into a cooler comprises pumping the liquid coolant from the coolant reservoir into the cooler.

16. The method of claim 14, further comprising: extracting heat from the liquid coolant in the cooler.

17. The method of claim 14, wherein introducing the liquid coolant into the housing comprises passing the liquid coolant from the cooler into the housing.

18. The method of claim 10, wherein creating a positive pressure within the housing includes introducing a gas into the housing.

19. The method of claim 18, wherein introducing a gas into the housing includes delivering an airstream from a low pressure air pump into the housing.

20. The method of claim 10, wherein introducing the liquid coolant into the housing comprises passing an amount of oil into the housing.
